(19) United States
(12) Patent Application Publication
(10) Pub. No.: US 2001/0048436 A1
(43) Pub. Date: Dec. 6, 2001

(54) Method and apparatus for sending electronic mail using human handwriting

(76) Inventor: Terence David Sanger, Brookline, MA (US)

Correspondence Address: Brian C. Dauphin, Esq., Mintz, Levin, Cohn, Ferris,, Glovsky and Popeo, P.C., One Financial Center, Boston, MA, 02111, US

(21) Appl. No.: 09/826,398

(22) Filed: Apr. 3, 2001

Related U.S. Application Data
(60) Provisional application No. 60/194,347, filed on Apr. 3, 2000.

(51) Int. Cl. G06T 11/00

(52) U.S. Cl. 345/467

(57) ABSTRACT

A web-based system for sending an electronic mail message containing simulated human handwriting includes a website having a user interface whereby an email sender can enter a message in text format directly into the website, convert the message into simulated handwriting and forward the email to a recipient, without having to download or install additional software. The email sender may tailor the appearance of the message by choosing from a variety of formatting parameters including character size, color, pen type and choice of script. From this information, a compressed graphic image of handwritten script is created, which may then be presented to the sender for preview or editing prior to being sent to the recipient. The generated compressed graphic images are encoded in standard formats (e.g., GIF or JPEG) and sent using standard email protocols, which are acceptable to most email readers, thereby eliminating the need for special-purpose software for the recipient.

### CROSS REFERENCE TO RELATED APPLICATIONS

This application claims the benefit of U.S. Provisional Patent Application having U.S. Ser. No. 60/194,347, filed on Apr. 3, 2000, entitled “METHOD AND APPARATUS FOR SENDING ELECTRONIC MAIL USING HUMAN HANDWRITING,” which is hereby incorporated by reference.

### FIELD OF THE INVENTION

The present invention is directed generally to computer generated simulated handwriting and more particularly to the generating and sending of electronic mail (email) containing simulated handwriting, wherein special-purpose software is not required for the sender or recipient.

### BACKGROUND OF THE INVENTION

Human handwriting is more personal than type written text, however, it is often more time consuming to create, especially when drafting and sending the same or similar message to more than one person (e.g., party or wedding invitations). One alternative is to simulate handwriting using computer software programs that convert typewritten text into text having a handwritten appearance. Currently, there are several products available for generating simulated human handwriting from typed text. These products include ByHand® software available from Sagittal Software, Inc., Personal Script® available from Signature Software, Inc. and software available from Social Software, Inc.

The ByHand® software is a unique technology for recording and reconstructing human handwriting on an electronic printer. It captures pen strokes made by a user on a pen tablet, separates these strokes into letters, stores the letter shapes in a database, and then reconstructs the letters as needed with smooth ligatures between letters. Mathematical models of calligraphic, ball point or felt tip pens are used to translate the letter shapes into graphics commands, which can be sent to a printer.

Personal Script® is software that provides for scanning of human handwriting samples and generating a font that mimics the handwriting from the sample. Handwriting is stored as a standard font, and alternative variations of several common letters are stored instead of rare characters in the set so that shapes with appropriate ligatures can be chosen. This software also allows their scripts to be used to generate graphic images (as JPEG files), which can be sent via email. Social Software provides software for printing connected handwritten script on a plotter.

Although this technology is adequate for generating simulated handwritten text for printing, it has not previously been used to generate electronic images of simulated handwriting intended to be sent as email.

Further, no technology based on smooth representation of individual letter strokes (including location and speed) has been used to generate email in a web-accessible manner that does not necessitate the sender or recipient having special-purpose software.

### SUMMARY OF THE INVENTION

The present invention overcomes the need for special-purpose software to send and receive email containing simulated handwriting, by providing a handwriting simulation software program that is implemented through a website.

In one embodiment of the present invention, the method for generating an electronic mail message containing simulated handwriting includes accessing a website having a user interface, entering a text message through the user interface and creating a graphic image of simulated handwriting that corresponds to the text message.

Another embodiment includes having a user specify one or more formatting parameters.

In an embodiment the user specifies a pen type.

In one embodiment the pen choices include, ballpoint, felt-tip and calligraphic pens.

In another embodiment the user chooses a degree of messiness.

In yet another embodiment, the user chooses the size of lettering.

In another embodiment the user chooses between a wandering text baseline and a straight text baseline.

In another embodiment the user chooses a type of handwriting script.

In another embodiment of the present invention, the method for creating a graphic image of simulated handwriting that corresponds to the text message includes accessing a database containing a chosen handwriting script database, selecting letter shapes from the handwriting script database that correspond to the text message, joining the letters shapes and drawing the strokes to create the graphic image.

In another embodiment of the present invention the graphic image that is created is a high-resolution image.

In another embodiment the high-resolution image is converted to a more compact low-resolution image through an anti-aliasing procedure.

In yet another embodiment of the present invention the low-resolution image is sent to a user for review.

In another embodiment of the present invention, the low-resolution image is sent to a recipient.

In another embodiment, a system for sending and receiving an electronic mail (email) message, wherein a portion of the email message has a handwritten appearance, includes a network, a first access device associated with an email sender and connected to the network, wherein the first access device further comprises means for entering a text message and formatting parameters, a second access device associated with an email recipient and connected to the network, and a server connected to both the first access device via the network and the second access device via the network, for receiving the text message from the first access device, for converting the text message into a graphic image containing simulated handwriting and for forwarding the graphic image to the second access device.

In another embodiment of the present invention, a method for converting a text message into a communication message containing a graphic image of simulated handwriting includes she steps of receiving a text message from a first site on a communications network, converting the text message into the end user communication message containing a graphic image of simulated handwriting, wherein the format of the communication message is capable of being recognized by a user and transmitting the converted communication message to the user at a second site.

In another embodiment of the present invention, a computer program, embodied on a computer readable medium, includes routines for converting a text message into an email message by first receiving the text message and a set of formatting parameters from a first site, converting the text message into a graphic image containing simulated handwriting, transmits the graphic image to a second site.

The website software, which includes routines to generate graphic images of handwriting as needed, allows a sender to enter a message in text format directly into the website, convert the message into graphic images of simulated handwriting and forward the email to a recipient, without having to download or install additional software.

These features are not possible using existing font technology, in which the images of letters are stored without possibility for “on-the-fly” modification.

### BRIEF DESCRIPTION OF THE DRAWINGS

For a better understanding of the present invention, reference is made to the drawings, which are incorporated herein by reference, and in which:

FIG. 1 is a block diagram illustrating physical components of one implementation of the present invention;

FIG. 2 is a flow chart depicting the operation of a method in accordance with one embodiment of the present invention for generating and sending email having a handwritten appearance; and

FIG. 3 is a flow chart depicting the operation of a method in accordance with one embodiment of the present invention for entering human handwriting and creating a script file.

### DETAILED DESCRIPTION

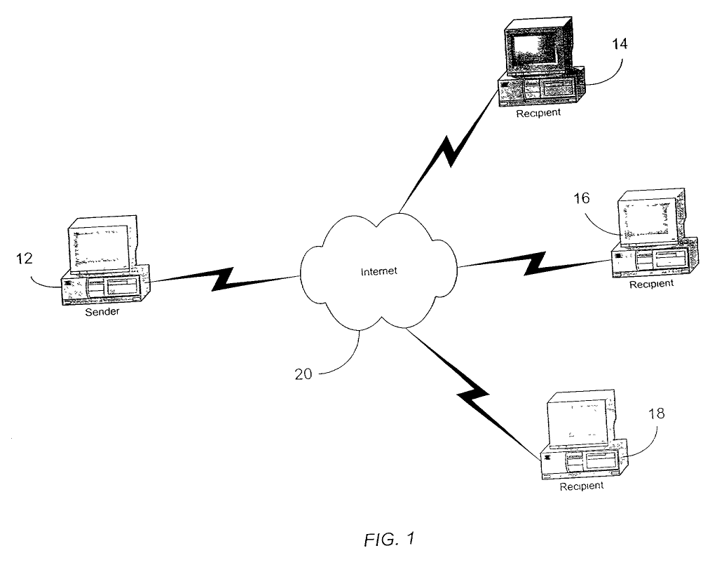

Turning now to the drawings, wherein like numerals designate corresponding parts throughout the drawings, FIG. 1 is a block diagram illustrating physical components 10 of one implementation of the present invention. While system configuration can take many forms in accordance with the scope of the present invention, the diagram of FIG. 1 illustrates an email sender 12 and email recipients 14, 16, 18, each shown connected to one another through an Internet 20, with conventional routers and switches omitted for clarity.

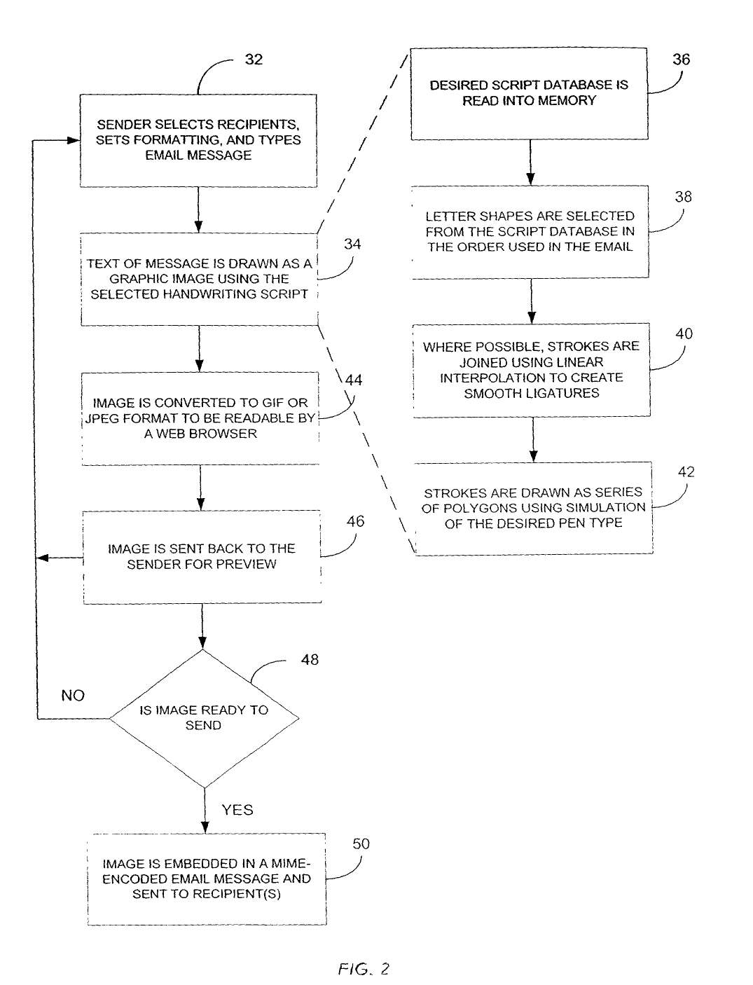

Referring now to FIG. 2, there is shown a flow chart depicting general operation steps 30 of the web-based system for generating and sending email having a handwritten appearance, in accordance with one embodiment of the invention. The sender 12 accesses a server on a website (not shown) on Internet 20 using a computer or one of a number of other known Internet access devices where he/she composes a textual email message in step 32. Sender 12 also specifies a choice of handwriting script, selects desired formatting parameters, including, character size, color, messiness and pen type and chooses an email recipient in step 32.

The sender's inputted text message is then converted into a graphic image using a software program on the server, as indicated in step 34. The text message, along with the chosen script and formatting parameters, are sent to the software program, which uses the message and parameters to generate a high-resolution graphic image in the chosen handwriting script. This is accomplished by first reading a database of the sender's chosen script into memory in step 36. Letter shapes are selected from the script database in the order of input of the sender's text message in step 38. Where possible, strokes are joined using linear interpolation to create smooth ligatures in step 40. Finally, individual strokes are drawn as a series of polygons using simulation of the desired pen type as indicted in step 42.

Preferably, the high-resolution image is then reduced to a more compact low-resolution image (e.g., GIF or JPEG) for improved on-screen viewing, using an anti-aliasing procedure, as indicated in step 44. The low-resolution image is then returned to the sender via his/her web browser for preview in step 46. Subsequently, as indicated in step 48, if the image is acceptable, the sender clicks a button, or otherwise signals acceptance, and the image, which is stored on the server, is converted and embedded in a Multipurpose Internet mail extension (MIME) encoded email and sent to sender forwarded to the desired recipient(s). In one embodiment, the email includes buttons for replying to the sender. The buttons direct the recipients web browser to an appropriate page on the website.

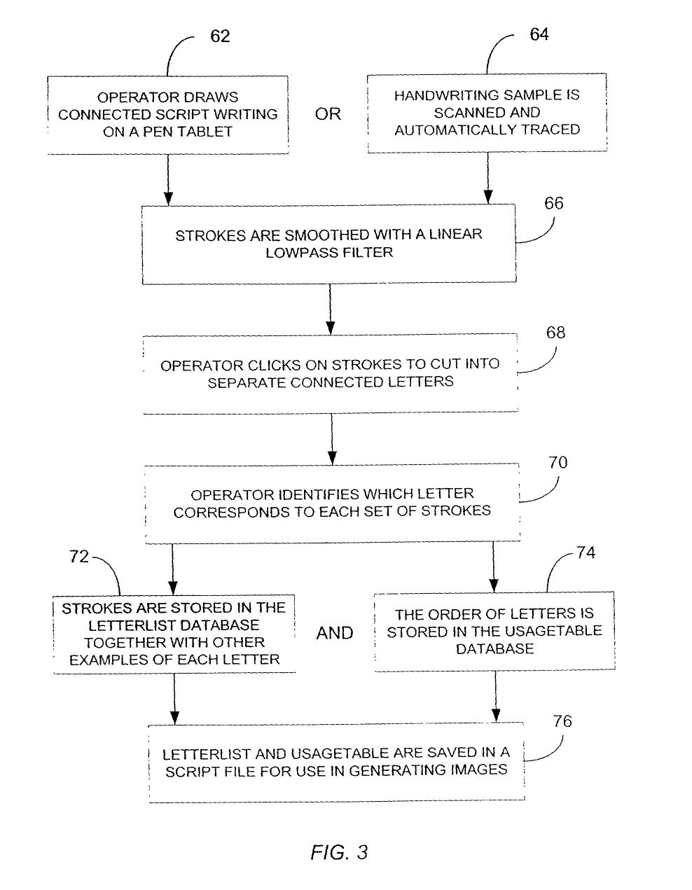

The handwriting script at the website is generated using stored human handwriting. In an embodiment of the present invention, the sender may select from preexisting handwriting scripts or create a unique script based on their own handwriting. Refer now to FIG. 3, which is a flow chart, showing general operation steps 60 for two alternate methods of entering human handwriting and creating a script file. According to a first method, as depicted in step 62, human handwriting is initially captured on a pen tablet as connected cursive or disconnected text. In steps 68, 70 the captured handwriting is displayed in an editing window in which the user can identify the breaks between letters and specify the correct character that each letter shape represents. For each letter, the sequence of pen movements including position, speed, and direction are stored in a database. The database has two components. The first part (“LetterList”), as depicted in step 72, is a sequence of letters, each of which is made from one or more strokes and contains relative scale information. The second part (“UsageTable”), as depicted in step 74, is a tree structure in which sequences of letters are stored in the order originally entered.

The tree structure is such that the parent of any node preceded the node, and the children of any node followed the node at the time the script was entered. In this way, if the database contains more than one example of a given letter, the appropriate example can be chosen to match the letters around it, based on the sequence of letters entered originally on the pen tablet. In particular, if a word was entered on the pen tablet and that word later appears in text to be translated into handwriting, then the handwriting will be reconstructed with exactly the same set of strokes originally used to generate the script database.

An alternative method for creating a database of human handwriting, as depicted in step 64, is to scan an image of handwriting, and then use an automatic tracing method to find the strokes that would have been used to generate the handwriting. Automatic tracing is implemented as a random walk along the darkened areas of an image, with the direction of the walk biased toward the direction in which a straight line drawn from the current walk location goes the longest distance before contacting a boundary of the letter image. After a sequence of traced points is generated, it is low-pass filtered, as depicted in step 66, and the curvature of the stroke is calculated at each point using standard methods. The speed is then set at each point to be proportional to the curvature raised to the ⅔ power, in accordance with the “⅔ power law” which is known to describe human arm movement. A new trace is then generated that simulates pen movements with speed according to the ⅔ power law, and this trace is used to generate strokes for the database as described above.

If a connected script is entered, then when “breaking” a stroke connecting two letters, each letter stores a short segment of the other letter beyond the break. Therefore, when reconstructing connected script, there will be a short region of overlap where pairs of strokes join. The simulated pen position in the overlap region is a weighted average of the two joined strokes, where the weighting uses a half-squared-cosine (sigmoidal) weighting function so that the two ends of the overlap region blend smoothly with the respective two letters. If the two letters to be joined were joined in the original handwriting sampling stage, then the characteristics of the join will be exactly reconstructed. If the sender desires, the baseline can wander unevenly to simulate uneven human handwriting. Ligatures between pairs of letters compensate automatically for drift of letters up or down the page.

The set of re-joined strokes generated from the desired text and the script database is then used to create a graphic image through the use of a pen simulator. In one embodiment, three pen types are available: ballpoint, felt-tip, and calligraphic, however, other pen types may be simulated. Each pen type can be generated using “normal” or “messy” ink. The ballpoint pen type has a constant thickness with rounded ends. It shows a solid color in the “normal” mode, but when messy there are frequent fine breaks in the stroke. The frequency of occurrence of these breaks increases with the speed of stroke movement, so that the writing becomes lighter at regions where the pen was moving faster in the original stroke capture step.

The felt-tip pen thickness varies inversely with pen speed, and changes in thickness are smoothed using an exponentially decaying finite impulse response deterministic filter. At each point along a stroke, the thickness is used to find left and right boundary points, which are joined to form the external border of a polygon. To maintain connectivity of the polygon, points on the exterior of a curve are interpolated linearly, and points on the inside are removed. Sharp corners are overprinted with circles of appropriate size, as is any region in which pen velocity is zero. The polygon is filled with a solid color. In “messy” mode, low-intensity white random noise is added to the locations of the polygon vertices to make an uneven edge.

The calligraphic pen thickness is proportional to the sine of the angle between the direction of pen movement and a 45-degree line, and the thickness is independent of pen velocity. A set of polygons is generated to indicate the outline of the figure for each set of strokes that does not include a segment at exactly 45 degrees. Each segment at 45 degrees is shown by a thin line rather than a polygon. In “messy” mode, the stroke is overlaid with a series of thin polygons that grow from zero width to a fraction of the total stroke width and then shrink again, so as to simulate the effect of brush hairs moving over paper.

The set of selected letters from the database is used to reconstruct smoothly joined strokes, which then send sequences of points to the desired pen simulation to produce polygon outlines. The polygons are drawn on a high-resolution bitmap in computer memory as a black-and-white image. A low resolution anti-aliased bitmap is generated, in which the intensity of each pixel is equal to the average intensity of a block of corresponding pixels in the high-resolution image. The color palette used to display the low resolution intensity image may be chosen by the sender.

The low-resolution image is encoded in either GIF or JPEG formats using third-party software. The email is a multipart MIME message in which the first part is an HTML document, which references an image. The image is stored in another part of the message as an encoded compressed digital file (either JPEG or GIF). As a result, the recipient 14, for example, on reading his/her email, sees the desired image. In addition, near the image are buttons that allow the recipient to reply to the sender, or to send a new handwritten message. Clicking these buttons causes the recipient to access the appropriate part of the website.

The sender completes information in an HTML form, which is then sent by the usual CGI (common gateway interface) formats to a program written in PERL which extracts the formatting information and creates a short text file labeled with the time of arrival of the request. A separate program monitors a directory for new text files, and if a file is found, selects the file with the earliest time of arrival (which is the alphabetically earliest filename), reads the parameters, constructs a graphic image of the handwriting as above, and writes the image to a specified JPEG or GIF file in another directory. When this file appears, the original PERL program then returns a preview image to the sender. If the sender clicks the “send” button, another CGI program reads the JPEG or GIF file, MIME-encodes it, adds an appropriate header and HTML reference, and emails it to the desired recipient. Success or failure is then conveyed to the sender via a web page.

Embodiments of the present invention account for the fact that human handwriting has natural variability, and letter shapes are typically modified to allow smooth flow between successive strokes. In human handwriting, certain letters may be written differently in specific common words such as “Dear” or “Yours”. A human can use the same handwriting but draw with different types of pens. These are features that cannot be simulated using fonts, which store only a small number of preformed graphic images, one for each letter.

The technology used in embodiments of the present invention, provides the ability to store pen strokes in a database which allows multiple different shapes for each letter, and which associates letters in pairs and larger groups that reflect the way particular letter shapes are used in particular letter sequences or words. This allows simulation of the natural variability in human handwriting. The disclosed features contribute to a greater sense of “natural” handwriting, as well as providing the user with a set of flexible features that help to convey the intended message in the email.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A method for generating an electronic mail message containing simulated handwriting, comprising the steps of:
accessing a website having a user interface;
entering a text message through the user interface;
creating a graphic image of simulated handwriting that corresponds to the text message.

2. The method for generating an electronic mail message containing simulated human handwriting of claim 1, further comprising a step of specifying one or more formatting parameters.

3. The method for generating an electronic mail message containing simulated human handwriting of claim 2, wherein the specifying step includes choosing a pen type.

4. The method for generating an electronic mail message containing simulated human handwriting of claim 3, wherein the pen types include ballpoint, felt-tip and calligraphic.

5. The method for generating an electronic mail message containing simulated human handwriting of claim 2, wherein the specifying step includes choosing a degree of messiness.

6. The method for generating an electronic mail message containing simulated human handwriting of claim 2, wherein the specifying step includes choosing size of lettering.

7. The method for generating an electronic mail message containing simulated human handwriting of claim 2, wherein the specifying step includes choosing between a wandering text baseline and a straight text baseline.

8. The method for generating an electronic mail message containing simulated human handwriting of claim 2, wherein the specifying step includes choosing a handwriting script.

9. The method for generating an electronic mail message containing simulated human handwriting of claim 8, wherein the creating step includes:
accessing a database containing the chosen handwriting script;
selecting letter shapes from the handwriting script database that correspond to the text message;
joining the letters shapes;
drawing the strokes to create the graphic image.

10. The method for generating an electronic mail message containing simulated human handwriting of claim 9, wherein the graphic image is a high-resolution image.

11. The method for generating an electronic mail message containing simulated human handwriting of claim 10, further comprising the step of reducing the high-resolution image to a more compact low-resolution image through an anti-aliasing procedure.

12. The method for generating an electronic mail message containing simulated human handwriting of claim 11, further comprising the step of reviewing the low-resolution image.

13. The method for generating an electronic mail message containing simulated human handwriting of claim 12, further comprising the step of sending the low-resolution image to a recipient.

14. A system for sending and receiving an electronic mail (email) message, wherein a portion of the email message has a handwritten appearance, comprising:
a network;
a first access device associated with an email sender and connected to the network, wherein the first access device further comprises means for entering a text message and formatting parameters;
a second access device associated with an email recipient and connected to the network; and
a server connected to both the first access device via the network and the second access device via the network, for receiving the text message from the first access device, for converting the text message into a graphic image containing simulated handwriting and for forwarding the graphic image to the second access device.

15. The system for sending and receiving an email message of claim 14, wherein the text message is converted into a graphic image using a software program on the server.

16. The system for sending and receiving an email message of claim 15, wherein the software program uses the text message and formatting parameters to generate a high-resolution graphic image.

17. A method for converting a text message into a communication message containing a graphic image of simulated handwriting, comprising the steps of:
receiving a text message from a first site on a communications network;
converting the text message into the end user communication message containing a graphic image of simulated handwriting, wherein the format of the communication message is capable of being recognized by a user; and
transmitting the converted communication message to the user at a second site.

18. A computer program embodied on a computer readable medium for converting a text message into an email message, said computer program accomplishing the steps of:
receiving a text message and a set of formatting parameters from an end user from a first site;
converting the text message into a graphic image containing simulated handwriting; and
transmitting the graphic image to at least one end user at a second site.
